(19) United States
(12) Patent Application Publication
(10) Pub. No.: US 2016/0263805 A1
(43) Pub. Date: Sep. 15, 2016

(54) DEVICE FOR FIXING EXTRUDED PLASTICS PROFILE

(71) Applicants: Carsten DEPPE, Kempen (DE); Jörg DRÖGE, Kerken (DE); BATTENFELD-CINCINNATI GERMANY GMBH, Bad Oeyenhausen (DE)

(72) Inventors: Carsten Deppe, Kempen (DE); Joerg Droege, Kerken (DE)

(21) Appl. No.: 15/028,734

(22) PCT Filed: Oct. 10, 2014
(86) PCT No.: PCT/EP2014/071818

§ 371 Date: Apr. 12, 2016

(30) Foreign Application Priority Data
Oct. 12, 2013 (DE) 10 2013 220 619.4

(51) Int. Cl. B29C 47/00; B25B 5/14

(52) U.S. Cl. CPC B29C 47/0066; B29C 47/0023; B25B 5/147; B29L 2023/22

(57) ABSTRACT

A device for profile extrusion, has at least three clamping arrangements disposed equidistantly around the perimeter of an extended profile, wherein a clamping element can be placed directly on the extended profile. The one clamping element can be mounted in each of the clamping arrangements and the clamping elements can be moved radially with respect to the extrusion axis by a drive mechanism, and each clamping arrangement is connected to the adjacent clamping arrangement by a coupling arrangement.

### CROSS-REFERENCE TO RELATED APPLICATIONS

This application is a U.S. national stage application under 35 U.S.C. §371 of International Application No. PCT/EP2014/071818, filed on Oct. 10, 2014, and claims benefit to German Patent Application No. DE 10 2013 220 619.4, filed on Oct. 12, 2013. The International Application was published in German on Apr. 16, 2015, as WO 2015/052338 A1 under PCT Article 21(2).

### FIELD

The invention relates to a device for profile extrusion.

### BACKGROUND

In particular in pipe extrusion, there are different requirements placed on partial areas during the extrusion process. Thus for example the melt strand has to be calibrated after leaving the extruder, guided into a cooling region or sealed off from the outside in a vacuum tank. In many applications, the pipe has to be clamped in order to cut it into lengths. At present, various tools, sealing regions and clamping devices are provided for all these functions.

For example, DE 10 2005 020 296 A1 proposes a device consisting of at least two parts, which can be placed directly on the profile to be extruded, in which each of the two parts has at least one contact surface which can be placed on the profile to be extruded, and the at least two parts are disposed such that the contact surfaces of the parts surround the profile to be extruded.

The two parts thus form in their arrangement in cross section a circular opening through which the profile to be extruded can be passed. Advantageously, the parts are configured such that they can be rotated or adjusted by simple means such that their contact surfaces form an outlet for different profile cross sections. In this case, it should be stressed in particular that this proposed solution makes it possible to set the device to a new cross section during production, i.e. online. This can be done using a suitable machine controller in which a central adjustment means is in a control connection therewith.

EP 2 085 169 A1 discloses a clamping means for an extruded pipe, in which two half shells are moved towards one another in order to clamp the pipe. For different pipe diameters, the half shells are exchanged.

A pipe cutter is known from OS 2 234 082, in which the pipe is fixed by adjustable jaws. The jaws are adjusted by screw bolts.

A flying die apparatus as described in U.S. Pat. No. 5,224,368 discloses a clamping means, in which a jaw mechanism in the form of a toggle mechanism is operated by a hydraulic drive mechanism in order to clamp a pipe.

### SUMMARY

An aspect of the invention provides a device for profile extrusion, the device comprising: a first clamping apparatus; a second clamping apparatus; and a third clamping apparatus, wherein the first, second, and third clamping apparatuses are disposed equidistantly around a perimeter of a profile to be extruded, wherein each of the first, second, and third clamping apparatuses includes a clamping element, respectively disposed in the first, second, or third clamping apparatuses, wherein the clamping element can be placed directly on the profile to be extruded, wherein the first, second, and third clamping elements can be moved radially with respect to an extrusion axis using a drive mechanism, and wherein each clamping apparatus is connected to an adjacent clamping apparatus using a coupling apparatus.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a typical extrusion line, and

FIG. 2 shows the clamping device part.

### DETAILED DESCRIPTION

An aspect of the invention relates to a device for profile extrusion, consisting of at least three clamping apparatuses disposed equidistantly around the perimeter of a profile to be extruded, wherein a clamping element can be placed directly on the profile to be extruded.

An aspect of the invention provides such clamping devices further, it being necessary to deal with the energy used in as energy-conscious and environmentally-conscious a manner as possible; furthermore, the device is intended to be of as simple a construction as possible.

TAn aspect of the invention is characterized in that the clamping element is disposed in each of the clamping apparatuses, and the clamping elements can be moved radially with respect to the extrusion axis by means of a drive mechanism, each clamping apparatus being connected to the adjacent clamping apparatus by means of a coupling apparatus.

This configuration can ensure that all the clamping apparatuses disposed around the pipe are adjusted at the same time, as a result of which a central position of the pipe around the extrusion axis is ensured. Thus, none of the clamping means can run ahead or behind.

According to one development, provision is made for three to eight clamping apparatuses to be disposed equidistantly around the profile. With two clamping apparatuses the pipe is already held securely with three clamping apparatuses, it is sufficiently centered. With more than three clamping apparatuses, the pipe is fixed in position in an even better manner.

According to a further development, it is proposed that all the clamping elements of all the clamping apparatuses provided can be moved by means of the drive mechanism, as a result of which all the clamping elements are adjusted synchronously, since, by means of the coupling, none of the clamping apparatuses can run ahead or behind.

Advantageously, the coupling apparatus is an articulated shaft provided with a transmission, and the clamping elements are connected to a toothed rack.

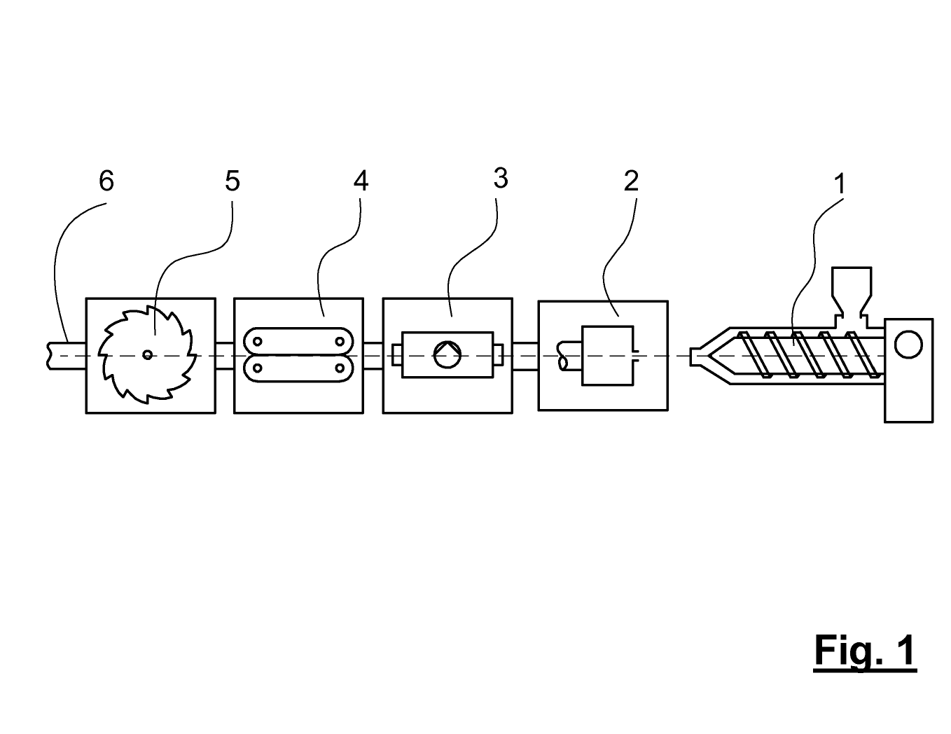

FIG. 1 shows a typical extrusion line, as is currently used for profile extrusion, regardless of whether it is for the production of window profiles or pipes. Said figure shows an extruder 1 in which plastics material is melted and is conveyed continuously into the extrusion die 2 for shaping. This is followed by a calibration and cooling station 3; further cooling stations may be used, depending on the profile. The cooling stations are followed by a withdrawal device 4. In order to cut the continuous profiles 6 to the desired length, a cutting device 5 is disposed downstream thereof.

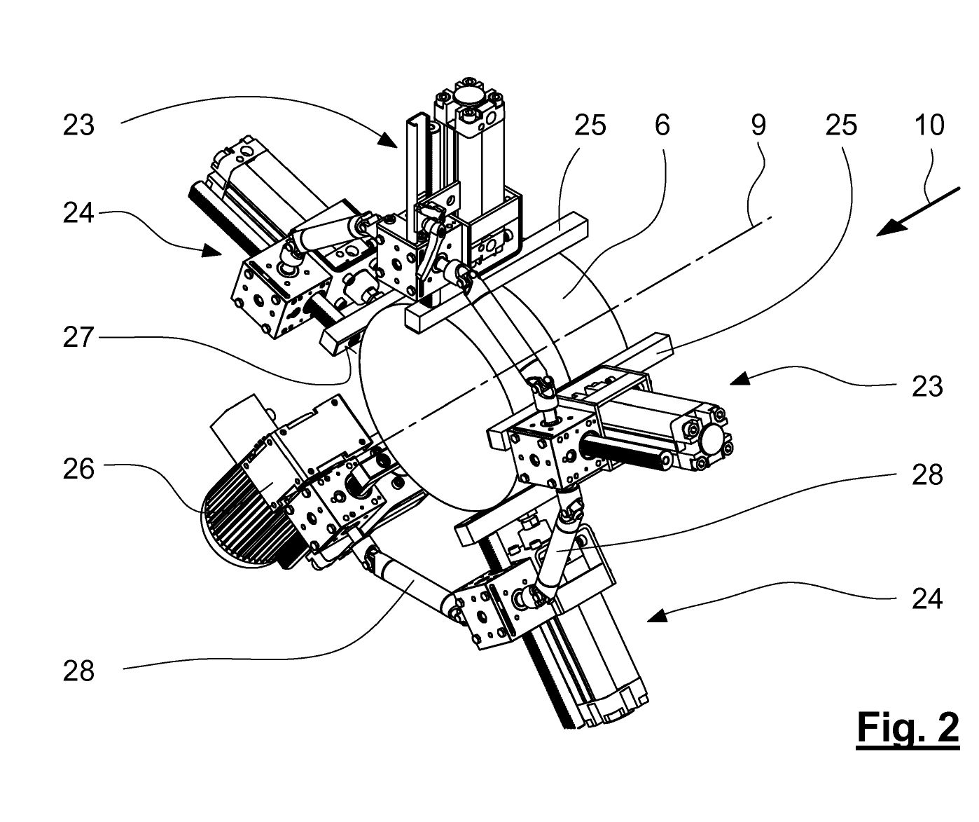

FIG. 2 is a schematic view of the clamping device according to the invention. It will preferably be used in the region of the cutting device 5, so that the profile 6 which is to be cut to length is fixed during the severing operation itself. It is however also conceivable to use the proposed clamping device at a different point in the extrusion line where it is necessary to fix the profile in position. The device can be used particularly well for fixing pipes in position, since the profile cross-section thereof is circular.

Part of the profile 6 is illustrated around the extrusion axis 9 in the direction of extrusion 10. The profile 6 is fixed in its position by means of clamping apparatuses. For this, a plurality of the clamping apparatuses are disposed so as to be distributed over the perimeter of the profile 6. All the clamping apparatuses provided are interconnected by means of coupling apparatuses 28, the coupling apparatus 28 in each case connecting a first clamping apparatus 23 to an adjacent second clamping apparatus 24.

Each of the clamping apparatuses provided has a clamping element 25, the contact surface 27 of which can be placed against the external surface of the profile 6. Each of the clamping apparatuses has an actuator, which is advantageously a servomotor, in order to move the clamping element radially with respect to the extrusion axis 9. One of the clamping apparatuses is equipped with a drive mechanism 26 which takes over the main control of the clamping apparatuses. Similarly to a server/client model, the additional clamping apparatuses which are connected via the coupling apparatus 28 follow the drive mechanism 26. This configuration ensures that all the clamping apparatuses disposed around the pipe 6 are adjusted synchronously, as a result of which a central position of the pipe 6 around the extrusion axis 9 is ensured.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE NUMERALS

1 extruder

2 extrusion die

3 calibration and cooling tank

4 withdrawal device

5 cutting device

6 profile

23 first clamping apparatus

24 second clamping apparatus

25 clamping element

26 drive mechanism for 23 and 24

27 contact surface of 25

28 coupling apparatus between 23 and 24

1. A device for profile extrusion, the device comprising:
a first clamping apparatus;
a second clamping apparatus; and
a third clamping apparatus,
wherein the first, second, and third clamping apparatuses are disposed equidistantly around a perimeter of a profile to be extruded,
wherein each of the first, second, and third clamping apparatuses includes a clamping element, respectively disposed in the first, second, or third clamping apparatuses,
wherein each clamping element to can be placed directly on the profile to be extruded,
wherein the first, second, and third clamping elements can be moved radially with respect to an extrusion axis using a drive mechanism, and wherein each clamping apparatus is connected to an adjacent clamping apparatus using a coupling apparatus.

2. The device of claim 1, comprising three to eight clamping apparatuses, disposed equidistantly around the profile.

3. The device of claim 1, wherein all the clamping elements of all the clamping apparatuses provided can be moved using the drive mechanism.

4. The device of claim 1, wherein the coupling apparatus is an articulated shaft provided with a transmission.

5. The device of claim 1, wherein the clamping elements are connected to a toothed rack.

6. The device of claim 2, wherein clamping elements of all the clamping apparatuses provided can be moved using the drive mechanism.

7. The device of claim 1, wherein the coupling apparatus includes an articulated shaft including a transmission.

8. The device of claim 2, wherein the coupling apparatus includes an articulated shaft including a transmission.

9. The device of claim 6, wherein the coupling apparatus includes an articulated shaft including a transmission.

10. The device of claim 2, wherein the clamping elements are connected to a toothed rack.

11. The device of claim 3, wherein the clamping elements are connected to a toothed rack.

12. The device of claim 4, wherein the clamping elements are connected to a toothed rack.

13. The device of claim 6, wherein the clamping elements are connected to a toothed rack.

14. The device of claim 1, comprising exactly three clamping apparatuses.

15. The device of claim 1, comprising exactly eight clamping apparatuses
